(19) United States
(12) Patent Application Publication
(10) Pub. No.: US 2017/0170684 A1
(43) Pub. Date: Jun. 15, 2017

(54) Battery Energy Storage System Management Apparatus, Battery Energy Storage System Management Method, and Battery Energy Storage System

(71) Applicant: Hitachi, Ltd., Tokyo (JP)

(72) Inventor: Fanny MATTHEY, Tokyo (JP)

(21) Appl. No.: 15/374,148

(22) Filed: Dec. 9, 2016

(30) Foreign Application Priority Data
Dec. 14, 2015 (JP) 2015-243068

(51) Int. Cl. H02J 13/00; G06Q 30/02; G05B 13/02; H02J 7/00

(52) U.S. Cl. CPC H02J 13/0003; H02J 7/0068; G06Q 30/0202; G05B 13/026

(57) ABSTRACT

In a BESS management apparatus, a history database stores operation history data related to operation history of a BESS and price history data related to price history of a service. A state estimation unit estimates a state of charge and a state of health of a battery. A simulation unit calculates a performance score of the BESS with respect to providing of the service based on the operation history data stored in the history database and the state of charge and the state of health of the battery estimated by the state estimation unit. A price prediction unit calculates a predicted price of the service based on the price history data stored in the history database. A control parameter selection unit selects a control parameter for controlling an operation of the BESS based on the performance score and the predicted price.

### BACKGROUND OF THE INVENTION

Field of the Invention

The present invention relates to a management apparatus and a management method of a battery energy storage system and a battery energy storage system using the management apparatus and the management method of the battery energy storage system.

Background Art

Recently, the importance of adopting an electric power system that generates power from renewable energy sources such as solar and wind energy sources is increasing with concerns over global warming. However, generating power from the renewable energy sources causes the power to fluctuate by the second or by the minute according to changes in weather conditions, negatively affecting the stability of frequency and voltage of the power which flows to a power grid and thus creating concerns.

Under the circumstances, service providers, which provide power stabilization services (ancillary services) with respect to the power grid in return for fees to operators of the power grid, are known. If necessary, the service providers perform charging and discharging by means of a battery energy storage system (BESS) which can store and discharge power using batteries, between the power grid and the BESS. Accordingly, the service providers provide power stabilization services by restricting fluctuations in the frequency and voltage of power which flows to the power grid, and thus acquire monetary profits.

The batteries used in the BESS degrade according to the operation conditions of the BESS and environmental conditions under which the BESS is placed. The capacities thereof gradually decrease, and the internal resistances thereof gradually increase. A decrease in the battery capacity leads to a reduced amount of power that can be charged or discharged by the BESS, and an increase in the internal resistance leads to a reduced amount of discharge current and an increased amount of heat loss. As a result, the usefulness of the BESS reduces year after year. For this reason, the service providers are asking for a technique which can restrict the degradation of the battery and deliver a good performance with the aims of maximizing the life of the BESS and maximizing a performance delivered within an operation period of the BESS.

Techniques described in U.S. Patent Application No. 2012/0323389 and International Publication No. 2014/076918 are known as the technique described above. In U.S. Patent Application No. 2012/0323389, a technique to control power service facilities based on market data is disclosed. In International Publication No. 2014/076918, a storage battery control device, which acquires a regulation command value with respect to charging and discharging of a storage battery and controls the charging and discharging of the storage battery based on the value, is disclosed.

### SUMMARY OF THE INVENTION

As described above, charging and discharging performance and the life of the storage battery decline due to the degradation. However, neither of the techniques described in U.S. Patent Application No. 2012/0323389 and International Publication No. 2014/076918 considers the degradation of the storage battery. For this reason, an optimum operation management of the BESS cannot be carried out according to a state of health of the storage battery in a case where the techniques are applied to controlling the BESS.

According to a first aspect of the invention, a battery energy storage system management apparatus for managing an operation of a battery energy storage system which provides a service to stabilize power supply with respect to a power grid using a chargeable and dischargeable battery includes: a history database that stores operation history data related to operation history of the battery energy storage system; a state estimation unit that estimates a state of health of the battery; and a control parameter selection unit that selects a control parameter for controlling the operation of the battery energy storage system based on the operation history data stored in the history database, the state of health of the battery estimated by the state estimation unit, and a predicted price of the service.

According to a second aspect of the invention, a battery energy storage system management method for managing an operation of a battery energy storage system which provides a service to stabilize power supply with respect to a power grid using a chargeable and dischargeable battery includes: storing operation history data related to operation history of the battery energy storage system in a database; and causing a computer to estimate a state of health of the battery, and to select a control parameter for controlling the operation of the battery energy storage system based on the operation history data stored in the database, the estimated state of health of the battery, and a predicted price of the service.

According to a third aspect of the invention, a battery energy storage system includes: the battery energy storage system management apparatus according to the first aspect, a chargeable and dischargeable battery; and a charging and discharging apparatus that controls charging and discharging of the battery based on a control parameter selected by the battery energy storage system management apparatus.

According to the invention, an optimum operation management of the BESS can be carried out according to a state of health of the storage battery.

### BRIEF DESCRIPTION OF THE DRAWINGS

FIG. 1 is a schematic configuration diagram of a battery energy storage system according to an embodiment of the invention.

FIG. 2 is a functional block diagram of a BESS management apparatus.

FIGS. 3A to 3C are views illustrating examples of a relationship between a charge or discharge power demand and a BESS response.

FIG. 4 is a functional block diagram of a simulation unit.

FIG. 5 is a flow chart of a sensitivity analysis conducted by the simulation unit.

FIG. 6 is a view illustrating operations of a performance score lower bound setting unit and a control parameter range determination unit.

FIG. 7 is a view illustrating an operation of an optimum degradation direction determination unit.

FIG. 8 is a view illustrating operations of a statistics processing unit and a control mode selection unit.

FIG. 9 is a functional block diagram of a control parameter selection unit.

FIG. 10 is a view illustrating an example of a relationship between the charge or discharge power demand and the BESS response in a case where charging and discharging are controlled with control parameters being combined.

### DETAILED DESCRIPTION OF THE INVENTION

In the following embodiment, a battery energy storage system which is simply called as BESS as described above will be explained.

In the United States and other countries or regions, there are organizations called a Regional Transmission Organization (RTO) and an Independent System Operator (ISO), which are operators conducting operation and maintenance of power grids. Such power grid operators are responsible for maintaining the frequency and voltage level of power supplied to consumers from the power grid within a constant range while using power generated in various power generation facilities. In addition to power grid operators, service providers which provide ancillary services to stabilize power supply, including frequency regulation, reactive power supply, voltage control, and black start, are known. Such service providers provide the power stabilization services described above by means of the aforementioned BESS, and generate revenues by receiving payments from the power grid operators in return for providing the services according to the content the services and the length of time that the services are provided. In addition, the payment that the service providers receive in return for providing the power stabilization services is also influenced by market clearing prices determined by bids made by a plurality of competitors. In order to maximize profits under such circumstances, the service providers need to ensure that the BESS can be operated at the highest possible performance level at minimum operating costs.

The aforementioned BESS used in providing the power stabilization services to the power grids is, in general, configured with a plurality of chargeable and dischargeable batteries, a power conditioning system, an air conditioning system which regulates a temperature within a facility where the BESS is provided, and a battery management system that controls the entire operation of the BESS, including charging and discharging of the batteries. Battery characteristics are expressed in capacity (Ah), internal resistance (Ω), state of charge (%), and the like. In addition, as the battery degrades, the capacity thereof decreases and the internal resistance thereof increases. Factors that degrade the battery include the charge and discharge range of the battery, the number and the frequency of charge and discharge cycle, charge and discharge currents, and an ambient temperature.

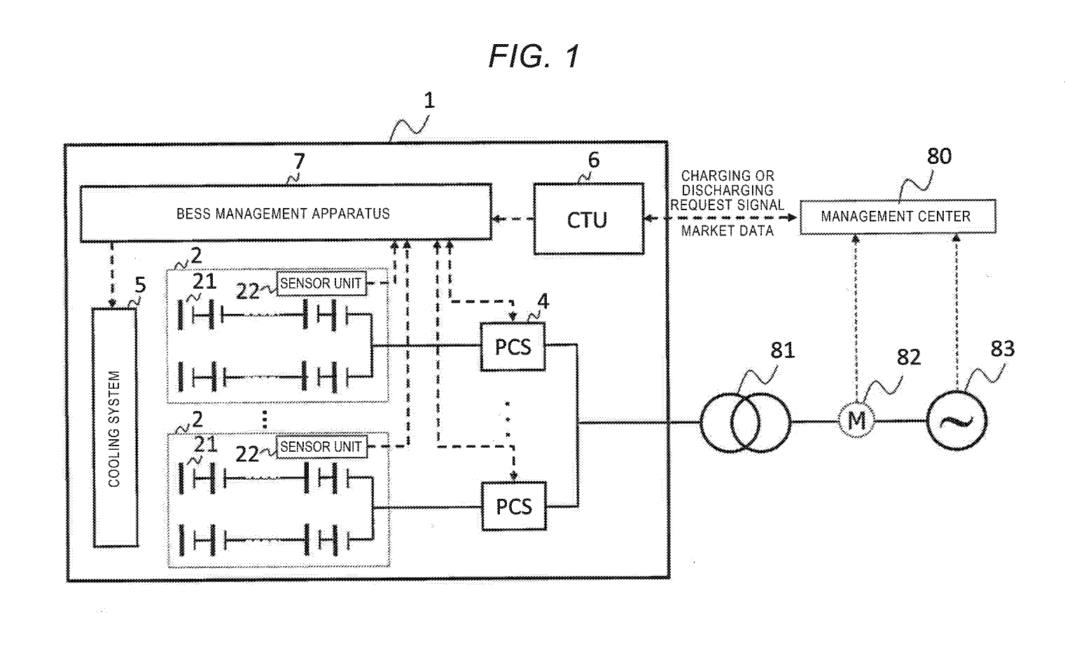

FIG. 1 is a schematic configuration diagram of the battery energy storage system according to the embodiment of the invention. A battery energy storage system (BESS) 1 illustrated in FIG. 1 has one or more power storage units 2, one or more power conditioning systems (PCS) 4, a cooling system 5, a communication terminal unit (CTU) 6, and a BESS management apparatus 7.

Each of the power storage units 2 has a plurality of battery cells 21 connected in series and in parallel, and a sensor unit 22. The battery cell 21 is a secondary battery that can be charged or discharged by converting chemical energy to electrical energy and vice versa through an electrochemical reaction. The sensor unit 22 has a voltage sensor, a current sensor, a temperature sensor, and the like, and outputs voltage, current, and temperature values of each of the battery cells 21 detected by the above sensors to the BESS management apparatus 7.

Each of the battery cells 21 of the power storage unit. 2 is connected to a transformer 81 via the PCS 4. The PCS 4 converts DC power from the battery cell 21 to AC power to output to the transformer 81, or, in contrast, coverts AC power from the transformer 81 to DC power to output to the battery cell 21. The operations of the battery cell 21 and the PCS 4 are controlled by the BESS management apparatus 7.

The cooling system 5 controls air conditioning to maintain a temperature inside a facility where the BESS 1 is provided within an appropriate temperature range which satisfies a safety and degradation rate of the battery cell 21. Accordingly, the temperature of the battery cell 21 is regulated to be at an appropriate level during the operation of the BESS 1. The operation of the cooling system 5 is controlled by the BESS management apparatus 7 based on the temperature of the battery cell 21 output from the sensor unit 22.

The BESS management apparatus 7 receives information transmitted from a management center 80 via the CTU 6. The management center 80 is provided at the aforementioned RTO and ISO which are organizations conducting operation and maintenance of a power grid 83, and transmits information indicating the content of service with respect to the BESS 1 requested by these organizations to the BESS 1. In addition, the BESS management apparatus 7 receives data of voltage, current, and temperature from the sensor unit 22 of each of the power storage units 2, and also receives data from the PCS 4. Based on the received data described above, the BESS management apparatus 7 controls charging and discharging of the battery cell 21 and the PCS 4, and controls the cooling system 5.

The BESS 1 is connected to the power grid 83 via the transformer 81, and provides the power grid 83 with power stabilization services such as frequency regulation. The BESS management apparatus 7 receives in real time, from the management center 80, a charging or discharging request signal according to the power demand of the power grid 83 or various types of market data related to power stabilization service payments. The BESS management apparatus 7 controls the operation of the BESS 1 by operating the PCS 4 and controlling the charging and discharging of the battery cell 21 based on the above signal and data. A power meter 82 is provided between the transformer 81 and the power grid 83. The management center 80 can monitor an operation state of the BESS 1 via the power meter 82.

The RTO and the ISO, which are the operators of the power grid 83, transmit the charging or discharging request signal and the market data from the management center 80 to the BESS 1, which is a source for providing power stabilization services. A response performance of the BESS 1 with respect to the charging or discharging request signal is expressed as a value called performance score in which a response rate and a response accuracy are reflected, and profits to be received by the service providers which operate the BESS 1 are determined based on the performance score. Meanwhile, the operation conditions of the BESS 1 have an effect on both of the degradation phenomenon and the performance score of the battery cell 21. For this reason, it is preferable for the service providers to select a control policy with respect to the charging and discharging of the BESS 1 such that the life of the BESS 1 can be maximized and the performance score acquired within an operation period of the BESS 1 can be maximized.

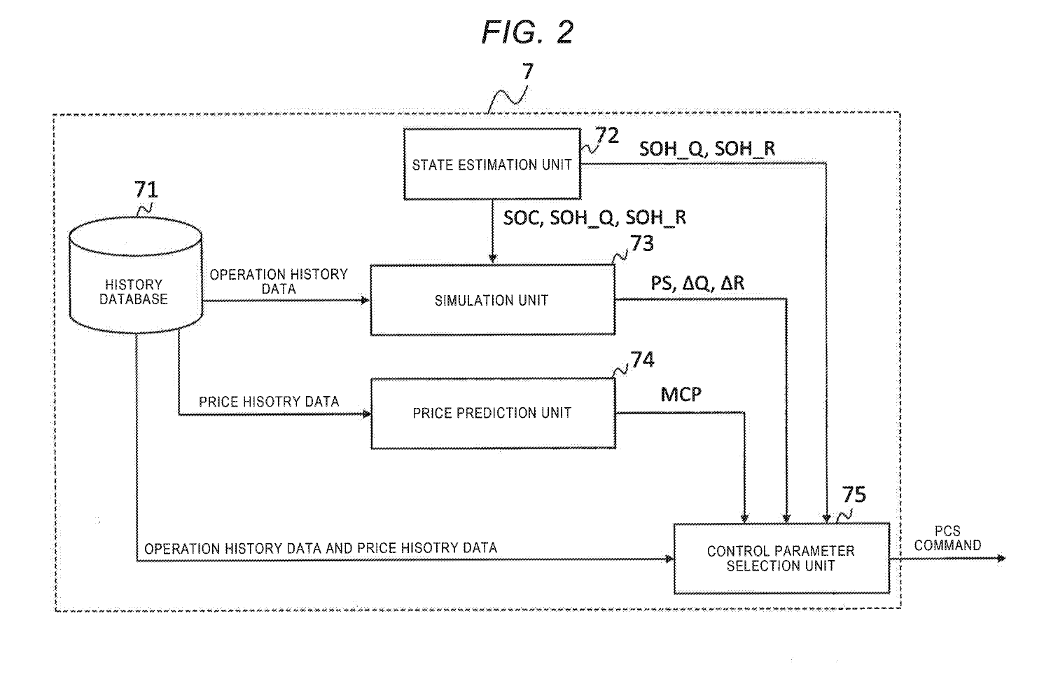

FIG. 2 is a functional block diagram of the BESS management apparatus 7. The BESS management apparatus 7 includes each of functional blocks of a history database 71, a state estimation unit 72, a simulation unit 73, a price prediction unit 74, and a control parameter selection unit 75. The functions in the aforementioned functional blocks are realized, for example, by a predetermined program being executed by a computer.

The history database 71 stores various types of history data correlated with time, including operation history data and price history data. The operation history data is data related to operation history of the BESS 1, and includes information of charging or discharging request signals received in the past from the management center 80, past control parameter information used in controlling the battery cell 21 and the PCS 4, and information of past performance scores. The management center 80 transmits, for example, a frequency regulation signal for stabilizing the frequency of the power grid 83 or the like, as a charging or discharging request signal, to the BESS 1. The price history data is data related to price history of past power stabilization services, and includes market data received from the management center 80 in the past. The management center 80 transmits, for example, information of market clearing prices and information related to weather as market data to the BESS 1.

The state estimation unit 72 estimates a state of charge of each of the battery cells 21 and a state of health with respect to a capacity and an internal resistance of each of the battery cells 21 based on information of voltage, current, temperature, and the like input from the sensor unit 22 of FIG. 1. In addition, the state estimation unit 72 outputs an estimated value SOC of state of charge to the simulation unit 73, and also outputs an estimated value SOH_Q of state of health in terms of capacity and an estimated value SOH_R of state of health in terms of internal resistance to the simulation unit 73 and the control parameter selection unit 75.

The simulation unit 73 acquires the operation history data from the history database 71, and also acquires the estimated value SOC of state of charge and each of the estimated values SOH_Q and SOH_R of state of health from the state estimation unit 72. Based on the aforementioned values, the simulation unit 73 conducts a sensitivity analysis of the BESS 1 by means of predetermined simulation processing, and calculates a performance score PS, a capacity fade amount ΔQ and an internal resistance increased amount ΔR for each control policy of the BESS 1. The aforementioned calculation results are output from the simulation unit 73 to the control parameter selection unit 75. Herein, a control parameter X_j is set for each control policy in the BESS 1. An identifier j of the control parameter X_j indicates a type of control policy, and satisfies 1≦j≦N (N is the number of applicable control policies).

The price prediction unit 74 acquires the price history data from the history database 71, and calculates a predicted price MCP of power stabilization service provided by the BESS 1 based on the price history data. Herein, the predicted price MCP of power stabilization service is calculated, for example, from information of past market clearing prices included in the price history data by calculating a predicted market clearing price at a time point when a future service is provided. The calculation results are output from the price prediction unit 74 to the control parameter selection unit 75.

The control parameter selection unit 75 acquires the operation history data and the price history data from the history database 71. In addition, the control parameter selection unit 75 acquires each of the information output from the state estimation unit 72, the simulation unit 73 and the price prediction unit 74. Based on the aforementioned information, the control parameter selection unit 75 determines a control policy expected to maximize both of the life and the performance score of the BESS 1, and selects a control parameter corresponding to the control policy from the control parameters X_j. Then, the control parameter selection unit 75 controls the charging and discharging of the battery cell 21 by outputting a control command with respect to the PCS 4 using the selected control parameter, thereby controlling the operation of the BESS 1.

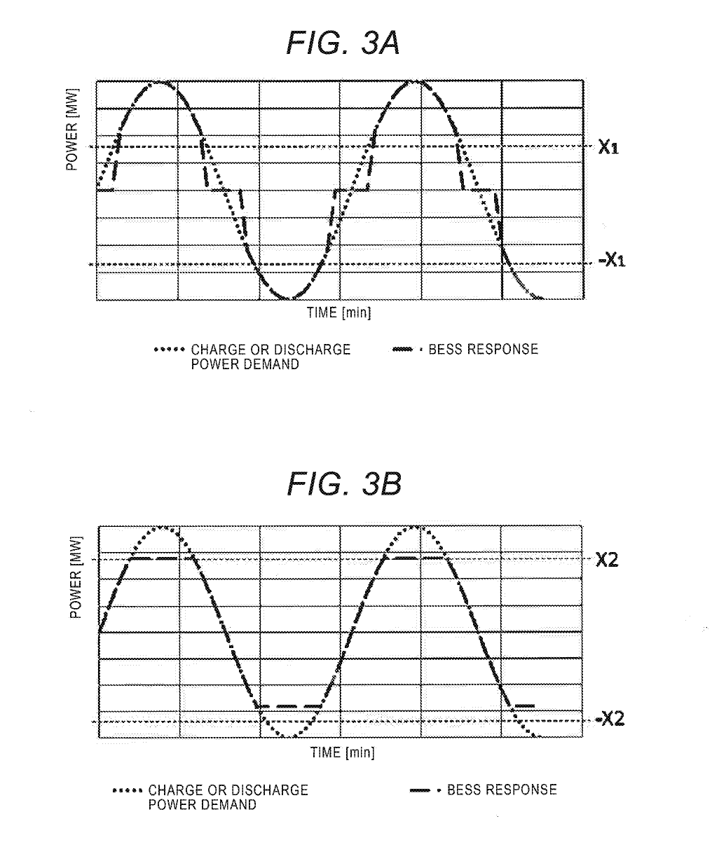

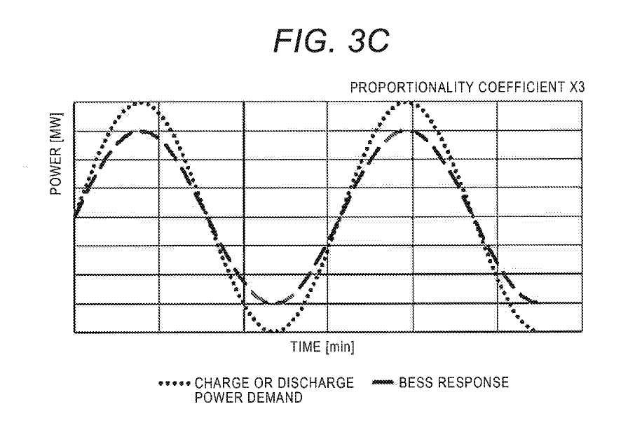

FIG. 3A, FIG. 3B, and FIG. 3C are views illustrating examples of a relationship between a charge or discharge power demand and a BESS 1 response according to control parameters X_j at times of j=1, 2, and 3.

FIG. 3A illustrates an example of a case where power that starts charging and discharging of the BESS 1 is determined by a control parameter X_1 (X_1>0) at a time of j=1. In this case, as illustrated in FIG. 3A, when an absolute value of charge or discharge power demand indicated by a power demand signal transmitted from the operator of the power grid 83 is lower than a value of the control parameter X_1, the BESS 1 is controlled such that neither of charging and discharging is carried out. On the other hand, once the absolute value of charge or discharge power demand exceeds the control parameter X_1, a service to stabilize power supply from the power grid 83 is provided by charging or discharging being conducted by the BESS 1 according to the charge or discharge power demand.

FIG. 3B illustrates an example of a case where power that limits charging and discharging of the BESS 1 is determined by a control parameter X_2 (X_2>0) at a time of j=2. In this case, as illustrated in FIG. 3B, when an absolute value of charge or discharge power demand indicated by a power demand signal transmitted from the operator of the power grid 83 is higher than the control parameter X_2, the BESS 1 is controlled such that no more charging or discharging is carried out. On the other hand, when the absolute value of charge or discharge power demand is lower than the control parameter X_2, a service to stabilize power supply from the power grid 83 is provided by charging or discharging being conducted by the BESS 1 according to the charge or discharge power demand.

FIG. 3C illustrates an example of a case where the charging and discharging of the BESS 1 is determined by a control parameter X_3 (X_3>0). In this case, as illustrated in FIG. 3C, the charge and discharge power of the BESS 1 is controlled by the charge or discharge power demand indicated by a power demand signal transmitted from the operator of the power grid 83 being multiplied by the control parameter X_3 as a proportionality coefficient.

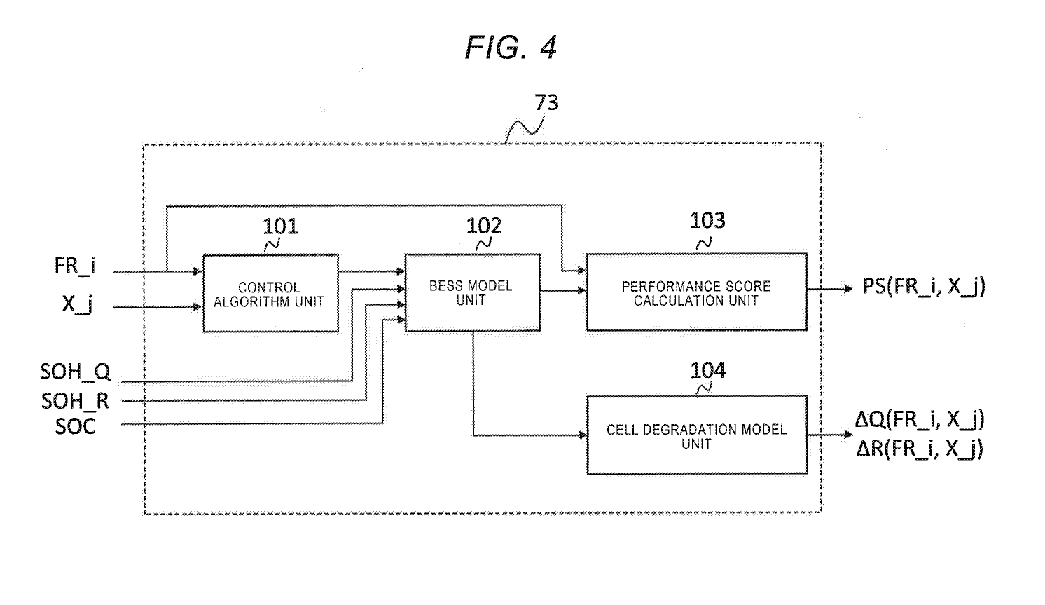

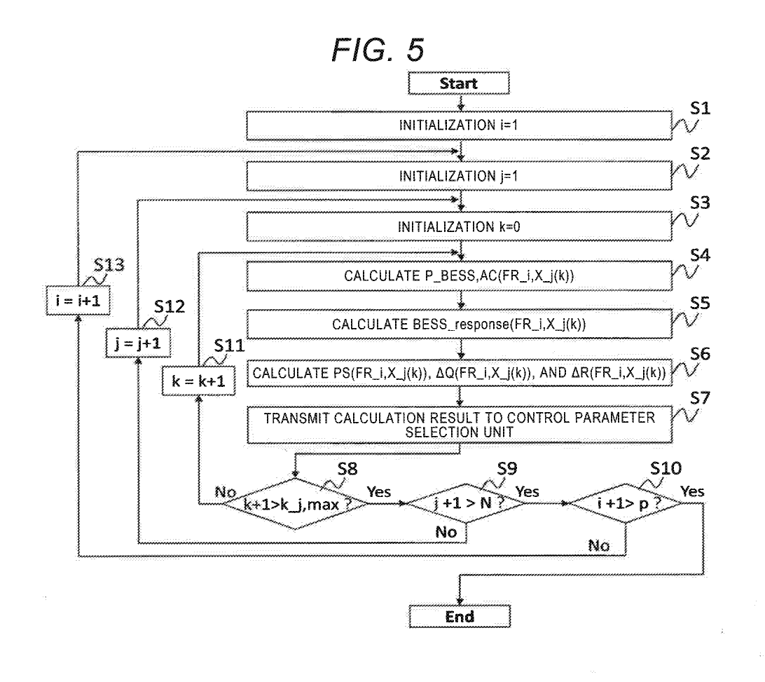

Hereinafter, the simulation unit 73 will be described in detail. FIG. 4 is a functional block diagram of the simulation unit 73. The simulation unit 73 includes each of functional blocks of a control algorithm unit 101, a BESS model unit 102, a performance score calculation unit 103, and a cell degradation model unit 104. The functions in the aforementioned functional blocks are realized, for example, by a predetermined program being executed by a computer.

In the control algorithm unit 101, a frequency regulation signal FR_i (1≦i≦p) and a control parameter X_j used in the operation control of the BESS 1 in the past are input based on the operation history data recorded in the history database 71. An upper bound p of an identifier i of the frequency regulation signal FR_i is determined according to the number of divisions and the number of histories of the frequency regulation signal FR_i included in the operation history data. For example, in a case where three days of daily history of the frequency regulation signal FR_i included in the operation history data is recorded, p is 3. Based on the aforementioned input data, the control algorithm unit 101 calculates the output power of the BESS 1 at each time point of the past. For example, an output power P_BESS,AC (FR_i,X_j) of the BESS 1 at each time point of the past is calculated by the following Equation (1) using a predetermined function f_j(FR_i,X_j) which has a frequency regulation signal FR_i and a control parameter X_j as arguments.

[Equation 1]

P_BESS,ΔC(FR_,X_j)=fⱼ(FR_i,X_j) (1)

BESS model information which is information on a model of the BESS 1 is stored in the BESS model unit 102. For example, the BESS model information, including the number of the battery cells 21 connected in series and in parallel in the power storage unit 2, the number of the PCS 4, a charge and discharge range or charge and discharge characteristics of the battery cell 21, and efficiency characteristics of the PCS 4, is stored in the BESS model unit 102. The BESS model unit 102 calculates a charge and discharge response BESS_response(FR_i,X_j) of the BESS 1 at each time point of the past based on the BESS model information, the output power of the BESS 1 calculated by the control algorithm unit 101, and the values of SOC, SOH_Q, and SOH_R input from the state estimation unit 72. The calculated charge and discharge response BESS_response(FR_i,X_j) is fed back into the BESS model unit 102, and is used in updating the BESS model information.

An algorithm for calculating a performance score is stored in the performance score calculation unit 103. The performance score calculation unit 103 calculates, using the algorithm, a performance score PS (FR_i,X_j) corresponding to the charge and discharge response BESS_response (FR_i,X_j) of the BESS 1 calculated by the BESS model unit 102.

The cell degradation model unit 104 stores cell degradation model information which is information on a model of a capacity fade and a model of an increase in internal resistance of the battery cell 21 due to degradation. For example, cell degradation model information acquired from a charge and discharge cycle test, a degradation test due to time, and the like conducted by the manufacturers of the battery cell 21 can be stored in the cell degradation model unit 104. The cell degradation model unit 104 calculates, using the cell degradation model information, a capacity fade amount ΔQ and an internal resistance increased amount ΔR that are corresponding to the charge and discharge response BESS_response(FR_i,X_j) of the BESS 1 calculated by the BESS model unit 102. For example, once the capacity fade amount ΔQ and the internal resistance increased amount ΔR with respect to time t are expressed as ΔQ(t) and ΔR(t), each of the values is acquired by the following Equations (2) and (3) using predetermined functions g_Q(t,I,ΔSOC,V) and g_R(t,I,ΔSOC,V) which have time t, current I, charge and discharge range ΔSOC, and voltage V as arguments. The cell degradation model unit 104 calculates the capacity fade amount ΔQ(FR_i,X_j) and the internal resistance increased amount ΔR(FR_i,X_j) that are corresponding to the charge and discharge response BESS_response(FR_i,X_j) based on the relationship expressed as Equations (2) and (3).

[Equation 2]

ΔQ(t)=g_{Q}(t,I,ΔSOC,V) (2)

[Equation 3]

ΔR(t)=g_{R}(t,I,ΔSOC,V) (3)

The simulation unit 73 can execute a sensitivity analysis of the BESS 1 by performing the aforementioned processing. As a result, the performance score PS(FR_i,X_j), the capacity fade amount ΔQ(FR_i,X_j), and the internal resistance increased amount ΔR(FR_i,X_j) are calculated with respect to frequency regulation signal FR_i and the control parameter X_j included in the operation history data. The calculated values are output from the simulation unit 73 to the control parameter selection unit 75, as described above.

In the sensitivity analysis executed by the simulation unit 73, once a value of control parameter X_j(1≦j≦N) with respect to a variable k is expressed as X_j(k), a value of the parameter X_j(k) is defined as the following Equation (4). In Equation (4), X_j,min indicates a lower bound of control parameter X_j, and σ_j indicates an augmentation factor of control parameter X_j. In addition, the variable k is any integer within a range of 0≦k≦k_j,max. A maximum value k_j,max of the variable k is set such that a relational expression of X_j(k_j,max) X_j,max is satisfied between an upper bound X_j,max of control parameter X_j and the maximum value k_j,max of the variable k. The X_j(k_j,max) in the relational expression indicates a value of control parameter X_j corresponding to the maximum value k_j,max of the variable k.

[Equation 4]

Xⱼ(k)=X_{j,min}+k·σⱼ (4)

FIG. 5 is a flow chart of the sensitivity analysis conducted by the simulation unit 73.

In Step S1, a value of i is initialized to 1 by the simulation unit 73.

In Step S2, a value of j is initialized to 1 by the simulation unit 73.

In Step S3, a value of k is initialized to 0 by the simulation unit 73.

In Step S4, the control algorithm unit 101 of the simulation unit 73 calculates output power P_BESS,AC(FR_i,X_j(k)) corresponding to each of the currently-set values of i, j, and k.

In Step S5, the BESS model unit 102 of the simulation unit 73 calculates a charge and discharge response BESS_response(FR_i,X_j(k)) corresponding to each of the currently-set values of i, j, and k based on the value of output power P_BESS,AC(FR_i,X_j(k)) calculated in Step S4.

In Step S6, the performance score calculation unit 103 of the simulation unit 73 calculates a performance score PS(FR_i,X_j(k)) corresponding to each of the currently-set values of i, j, and k based on the value of charge and discharge response BESS_response(FR_i,X_j(k)) calculated in Step S5. In addition, the cell degradation model unit 104 of the simulation unit 73 calculates a capacity fade amount ΔQ(FR_i,X_j(k)) and an internal resistance increased amount ΔR(FR_i,X_j(k)) corresponding to each of the currently-set values of i, j, and k based on the value of charge and discharge response BESS_response(FR_i,X_j(k)) calculated in Step S5.

In Step S7, the simulation unit 73 outputs the performance score PS(FR_i,X_j(k)), the capacity fade amount ΔQ(FR_i,X_j(k)), and the internal resistance increased amount ΔR(FR_i,X_j(k)) calculated in Step S6 to the control parameter selection unit 75.

In Step S8, the simulation unit 73 compares a value of k+1 obtained by adding 1 to the current value of k with a maximum value k_j,max of k corresponding to the current value of j. As a result, if k+1 is higher than the maximum value k_j,max, processing proceeds to Step S9, and if k+1 is equal to or lower than the maximum value k_j,max, processing proceeds to Step S11.

In Step S9, the simulation unit 73 compares a value of j+1 obtained by adding 1 to the current value of j with a maximum value N of j. As a result, if j+1 is higher than the maximum value N, processing proceeds to Step S10, and if j+1 is equal to or lower than the maximum value N, processing proceeds to Step S12.

In Step S10, the simulation unit 73 compares a value of i+1 obtained by adding 1 to the current value of i with a maximum value p of i. As a result, if i+1 is higher than the maximum value p, processing of the flow chart in FIG. 5 is terminated, and if i+1 is equal to or lower than the maximum value p, processing proceeds to Step S13.

In Step S11, the simulation unit 73 adds 1 to the current value of k. Once Step S11 is executed, processing returns to Step S4.

In Step S12, the simulation unit 73 adds 1 to the current value of j. Once Step S12 is executed, processing returns to Step S3.

In Step S13, the simulation unit 73 adds 1 to the current value of i. Once Step S13 is executed, processing returns to Step S2.

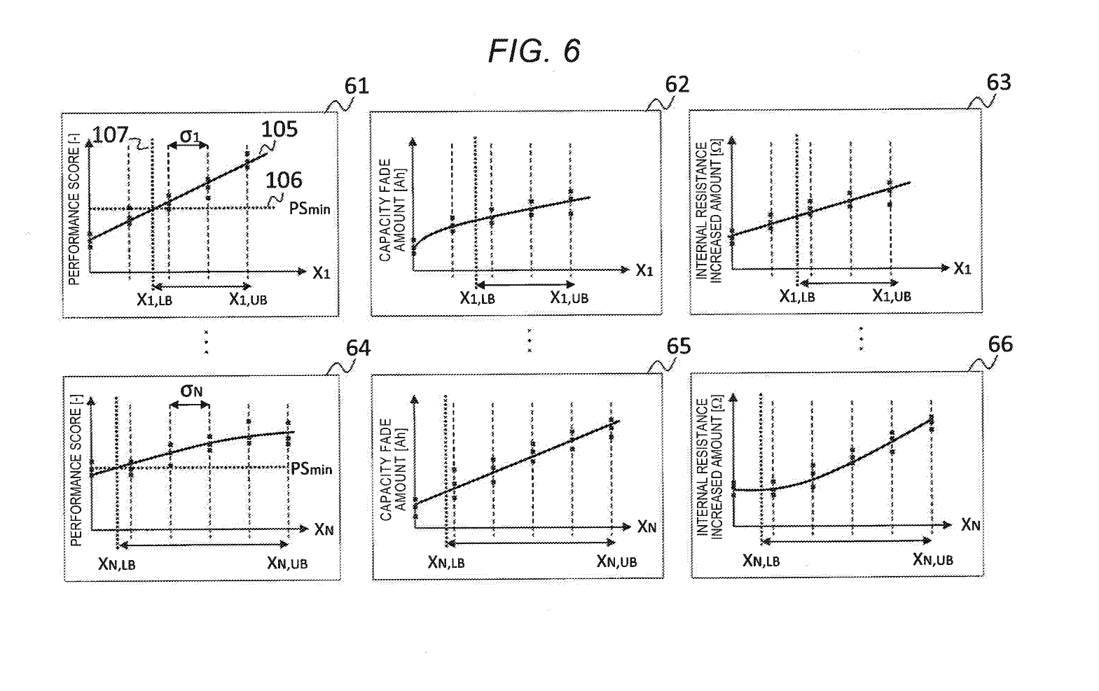

Hereinafter, the selection of a control parameter by the control parameter selection unit 75 will be described with reference to FIGS. 6 to 9.

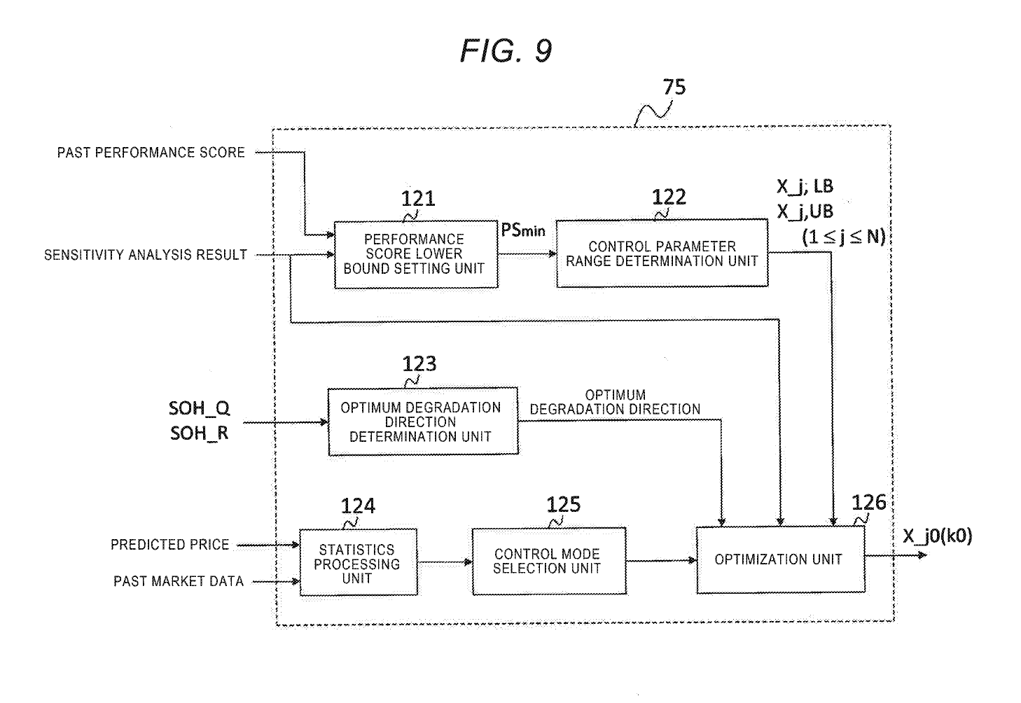

FIG. 9 is a functional block diagram of the control parameter selection unit 75. The control parameter selection unit 75 includes functional blocks of each of a performance score lower bound setting unit 121, a control parameter range determination unit 122, an optimum degradation direction determination unit 123, a statistics processing unit 124, a control mode selection unit 125, and an optimization unit 126. The functions in the aforementioned functional blocks are realized, for example, by a predetermined program being executed by a computer.

The performance score lower bound setting unit 121 sets a lower bound PSmin of performance score based on information of the past performance score included in the operation history data stored in the history database 71 and the sensitivity analysis results from the simulation unit 73.

The control parameter range determination unit 122 determines a range of control parameter to be used in controlling the BESS 1 based on the lower bound PSmin of the performance score set by the performance score lower bound setting unit 121.

The optimum degradation direction determination unit 123 determines an optimum degradation direction that indicates an optimum combination of actual degradation conditions of a capacity and an internal resistance of the battery cell 21 based on an estimated value SOH_Q of state of health in terms of capacity and an estimated value SOH_R of state of health in terms of internal resistance that are estimated by the state estimation unit 72.

The statistics processing unit 124 conducts predetermined statistics processing to set a price threshold for selecting a control mode based on the predicted price MCP of power stabilization service calculated by the price prediction unit 74 and the past market data included in the price history data stored in the history database 71.

The control mode selection unit 125 selects a control mode of the BESS 1 based on the price threshold set by the statistics processing unit 124.

The sensitivity analysis results from the simulation unit 73, the range of control parameter determined by the control parameter range determination unit 122, the optimum degradation direction determined by the optimum degradation direction determination unit 123, and the control mode selected by the control mode selection unit 125 are input in the optimization unit 126. The optimization unit 126 determines a control policy of the BESS 1 based on the input information, and selects a control parameter X_j0 corresponding to the control policy. Then, with respect to the selected control parameter X_j0, the optimization unit 126 sets an optimum value k0 of the variable k according to a control mode, and outputs a control parameter value X_j0(k0) corresponding to the optimum value k0 as a control command to the PCS 4.

The control parameter selection unit 75 selects a control parameter to be used in controlling the BESS 1 by each of the aforementioned functional blocks processing being executed.

FIG. 6 is a view illustrating operations of the performance score lower bound setting unit 121 and the control parameter range determination unit 122. Each of points on graphs 61 to 66 of FIG. 6 indicates an example of each of sensitivity analysis results input from the simulation unit 73 to the performance score lower bound setting unit 121. Each of the points on the graphs 61 to 63 of FIG. 6 indicates a performance score PS(FR_i,X_1(k)), a capacity fade amount ΔQ(FR_i,X_1(k)), and an internal resistance increased amount ΔR(FR_i,X_1(k)), respectively, with respect to a control parameter X_1 at a time of j=1. Each of the points on the graphs 64 to 66 indicates a performance score PS(FR_i,X_N(k)), a capacity fade amount ΔQ(FR_i,X_N(k)), and an internal resistance increased amount ΔR(FR_i,X_N(k)), respectively, with respect to a control parameter X_N at a time of j=N. Although description of a case of 2≦j≦N−1 is omitted in FIG. 6, even in that case, similar sensitivity analysis results with the graphs 61 to 66 are acquired.

The performance score lower bound setting unit 121 sets a lower bound PSmin of performance score based on the sensitivity analysis results illustrated in FIG. 6. Specifically, for example, by initially setting a fitting curve 105 for each of the points on the graph 61 with respect to the sensitivity analysis results illustrated in graph 61, the performance score lower bound setting unit 121 acquires a relationship between a control parameter X_1 and a performance score PS(X_j(k)) at the times of i=1 to p. Similarly, by setting a fitting curve for each of the points on the graphs 62 and 63 as well, the performance score lower bound setting unit 121 acquires a relationship between a control parameter X_1 and a capacity fade amount ΔQ(X_j(k)) and a relationship between a control parameter X_1 and an internal resistance increased amount ΔR(X_j(k)) at times of i=1 to p. Then, the performance score lower bound setting unit 121 sets a lower bound PSmin of performance score indicated by the reference numeral 106 in the graph 61 based on information of the past performance score included in the operation history data stored in the history database 71. The lower bound PSmin of performance score, for example, is determined from a value of performance score required for the BESS 1 to maintain sufficient competitiveness in a market for providing power stabilization services.

The control parameter range determination unit 122 determines a lower bound X_1,LB and an upper bound X_1,UB of the control parameter X_1 based on the fitting curve 105 and the lower bound PSmin of performance score set by the performance score lower bound setting unit 121. The lower bound X_1,LB indicated by the reference numeral 107 is acquired as a point of intersection of the fitting curve 105 and the lower bound PSmin of performance score. In addition, an interval between respective points in a horizontal direction on the graph 61 indicates an augmentation factor σ_1 at a time of j=1 in the aforementioned Equation (4).

As described above, once the lower bound X_1,LB and the upper bound X_1,UB of the control parameter X_1 are determined, the control parameter range determination unit 122 outputs the values to the optimization unit 126.

The performance score lower bound setting unit 121 and the control parameter range determination unit 122 execute the processing described above with respect to each of control parameters X_j(j=1 to N) for the sensitivity analysis results from the simulation unit 73. Accordingly, a lower bound X_j,LB and an upper bound X_j,UB of each of the control parameters X_j are determined, and thus a range of control parameter is determined. In addition, a relationship between each of the control parameters X_j and a performance score PS(X_j(k)), a capacity fade amount ΔQ(X_j(k)), and an internal resistance increased amount ΔR(X_j(k)) corresponding to each control parameter X_j is acquired.

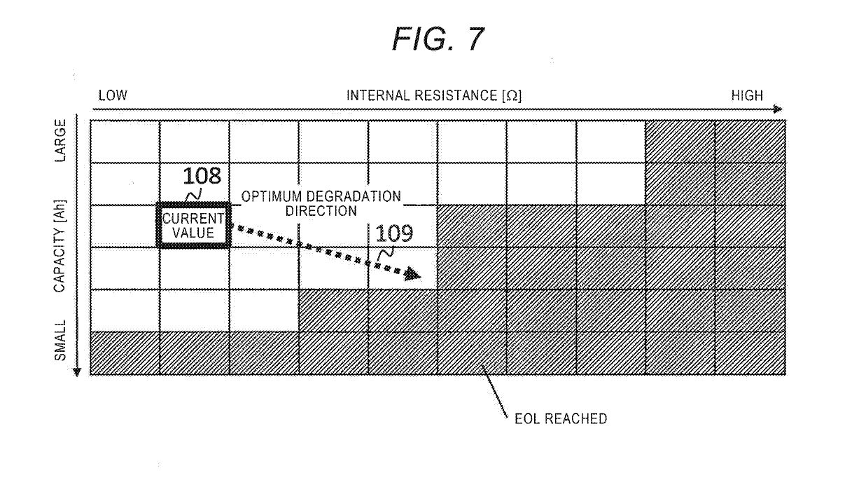

FIG. 7 is a view illustrating an operation of the optimum degradation direction determination unit 123. FIG. 7 illustrates an example of an EOL characteristics table indicating a relationship between an capacity fade and an internal resistance increased amount, both of which caused by the degradation of the battery cell 21. In the EOL characteristics table, a hatched portion indicates a region in which the end of life (EOL) is determined to be reached as a result of the degradation caused by at least any one of the capacity and the internal resistance of the battery cell 21.

The optimum degradation direction determination unit 123 specifies a current state of health of the battery cell 21, indicated by, for example, the reference numeral 108, on the EOL characteristics table based on an estimated value SOH_Q of state of health in terms of capacity and an estimated value SOH_R of state of health in terms of internal resistance that are input from the state estimation unit 72. Once the current state of health of the battery cell 21 is specified as described above, the optimum degradation direction determination unit 123 determines the direction indicated by an arrow 109 of which a distance to an EOL region in a lower-right direction is the farthest as an optimum degradation direction out of lower-right directions from the arrow 109. The optimum degradation direction 109 indicates a ratio between a capacity fade amount ΔQ and an internal resistance increased amount ΔR at which the time for the battery cell 21 to reach the end of life from the start of the battery cell 21 degradation is the longest. That is, by controlling the charging and discharging of the battery cell 21 such that the ratio between the capacity fade amount ΔQ and the internal resistance increased amount ΔR corresponds to a value indicated by the optimum degradation direction 109, a value of performance score PS can be secured to a certain degree while restricting the degradation of the battery cell 21.

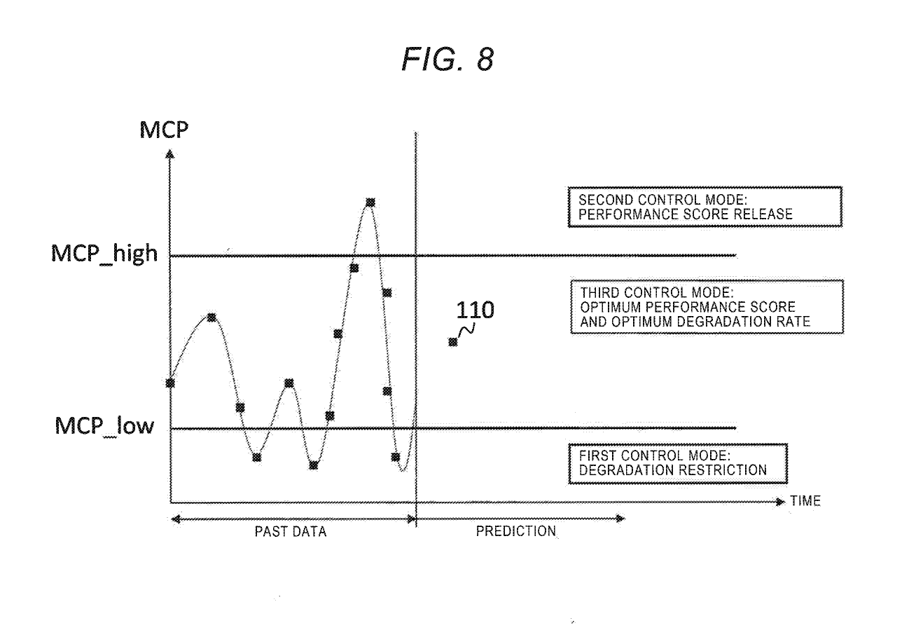

FIG. 8 is a view illustrating operations of the statistics processing unit 124 and the control mode selection unit 125. FIG. 8 illustrates an example of a relationship between a price fluctuation state of the past power stabilization services and a predicted price MCP of the power stabilization services calculated by the price prediction unit 74. The statistics processing unit 124 acquires, for example, the price fluctuation state illustrated in FIG. 8 based on the past market data included in the price history data stored in the history database 71. The statistics processing unit 124 sets two price thresholds MCP_high and MCP_low as illustrated in FIG. 8 with respect to the price fluctuation state by means of processing using a known statistics technique. The price threshold MCP_high corresponds to a threshold on an upper side, that is a higher price side, and the price threshold MCP_low corresponds to a threshold on a lower side, that is a lower price side. Herein, although an example of setting two price thresholds have been described, one price threshold or at least three price thresholds may be set.

The control mode selection unit 125 compares a predicted price MCP input from the price prediction unit 74 with the above price thresholds MCP_high and MCP_low set by the statistics processing unit 124, and sets a control mode based on the comparison results. Specifically, any one of the following three types of control modes is selected.

In a case where the predicted price MCP is lower than the price threshold MCP_low on the lower side, the control mode selection unit 125 selects a first control mode. In the first control mode of the BESS 1, charging and discharging are controlled such that the degradation restriction of the battery cell 21 takes priority over the performance score.

In a case where the predicted price MCP is higher than the price threshold MCP_high on the upper side, the control mode selection unit 125 selects a second control mode. In the second control mode of the BESS 1, charging and discharging are controlled such that the performance score takes priority over the degradation restriction of the battery cell 21 and the highest performance score is obtained.

In a case where the predicted price MCP is in between the price threshold MCP_high on the upper side and the price threshold MCP_low on the lower side, the control mode selection unit 125 selects a third control mode. In the third control mode of the BESS 1, charging and discharging are controlled such that the degradation restriction of the battery cell 21 is compatible with the performance score and the degradation of the battery cell 21 is restricted while acquiring a high performance score.

The control mode selection unit 125 selects a control mode of the BESS 1 as described above. In an example of FIG. 8, the predicted price MCP indicated by the reference numeral 110 is in between the price threshold MCP_high on the upper side and the price threshold MCP_low on the lower side. Therefore, in this case, the third control mode is selected.

The optimization unit 126 determines a control policy with respect to the BESS 1 in accordance with the control mode selected by the control mode selection unit 125, and selects a control parameter X_j0 corresponding to the control policy. Then, an optimum value k0 of the variable k is set with respect to the selected control parameter X_j0, and a control parameter value X_j0(k0) corresponding to the optimum value k0 is acquired. Specifically, with respect to the three types of control modes described above, each of control parameter values X_j0(k0) is determined as follows.

In a case where the first control mode is selected, the optimization unit 126 acquires, based on the aforementioned fitting curve, values of j and k which cause each of a capacity fade amount ΔQ(X_j) and an internal resistance increased amount ΔR(X_j) to reach a minimum level, in an entire range from a lower bound X_j,LB to an upper bound X_j,UB of each of control parameters X_j determined by the control parameter range determination unit 122. Then, a control parameter value X_j0(k0) is determined with the acquired values of j and k being set as j0 and k0 respectively.

In a case where the second control mode is selected, the optimization unit 126 acquires, based on the aforementioned fitting curve, values of j and k which cause the performance score PS (X_j(k)) to reach a maximum level, in the entire range from a lower bound X_j,LB to an upper bound X_j,UB of each of control parameters X_j. Then, a control parameter value X_j0(k0) is determined with the acquired values of j and k being set as j0 and k0 respectively. In a case where a plurality of combinations of values j and k, which cause the performance score PS (X_j(k)) to reach the maximum level, exist, a combination which causes a capacity fade amount ΔQ(X_j) and an internal resistance increased amount ΔR(X_j) to reach minimum levels thereof may be selected from the plurality of combinations.

In a case where the third control mode is selected, the optimization unit 126 acquires values of j and k which cause a ratio of a capacity fade amount ΔQ(X_j) to an internal resistance increased amount ΔR(X_j) coincides with an optimum degradation direction determined by the optimum degradation direction determination unit 123 and cause the performance score PS(X_j(k)) to reach a maximum level, in the entire range from a lower bound X_j,LB to an upper bound X_j,UB of each of control parameters X_j. Then, a control parameter value X_j0(k0) is determined with the acquired values of j and k being set as j0 and k0 respectively.

The optimization unit 126 can select a control policy according to any one of control modes by determining a value of j0 as described above. Then, an optimum control parameter value X_j0(k0) is determined according to the selected control policy, and the PCS 4 can be controlled.

According to the embodiment of the invention described above, the following effects are achieved.

(1) The BESS management apparatus 7 is an apparatus for managing the operation of the BESS 1 that provides services to stabilize power supply to the power grid 83, using the chargeable and dischargeable battery cell 21. The BESS management apparatus 7 includes the history database 71, the state estimation unit 72, and the control parameter selection unit 75. The history database 71 stores operation history data related to the operation history of the BESS 1. The state estimation unit 72 estimates a state of health of the battery cell 21. The control parameter selection unit 75 selects a control parameter for controlling the operation of the BESS 1 based on the operation history data stored in the history database 71, the state of health of battery cell 21 estimated by the state estimation unit 72, and predicted prices of services. Therefore, an optimum operation management of the BESS 1 can be carried out according to the state of health of the battery cell 21, which is a storage battery.

(2) The state estimation unit 72 further estimates a state of charge of the battery cell 21. The BESS management apparatus 7 further includes the simulation unit 73 that calculates a performance score of the BESS 1 with respect to providing of services based on the operation history data stored in the history database 71 and the state of charge and the state of health of the battery cell 21 estimated by the state estimation unit 72. The control parameter selection unit 75 selects a control parameter based on the performance score and the predicted price. Therefore, the degrees and prices of services provided by the BESS 1 are appropriately predicted and thereby an optimum control parameter can be selected.

(3) The simulation unit 73 calculates each of performance scores PS(FR_i,X_j) with respect to a plurality of control parameters X_j set for each control policy. Therefore, an optimum operation management of the BESS 1 can be carried out in view of performance scores different for each control policy.

(4) The simulation unit 73 further calculates each of a capacity fade amount ΔQ(FR_i,X_j) and an internal resistance increased amount ΔR(FR_i,X_j) of the battery cell 21 with respect to a plurality of control parameters X_j. The control parameter selection unit 75 selects a control parameter X_j0 to be used in controlling the BESS 1 based on the performance score PS(FR_i,X_j), the predicted price MCP, and the capacity fade amount ΔQ(FR_i,X_j) and the internal resistance increased amount ΔR(FR_i,X_j) of the battery cell 21. Therefore, an optimum operation management of the BESS 1 can be carried out in view of the actual states of health of the battery cell 21 different for each control policy as well.

(5) The history database 71 further stores price history data related to price history of services. The BESS management apparatus 7 further includes the price prediction unit 74 that calculates predicted prices of services based on the price history data stored in the history database 71. Therefore, the predicted prices of services can be accurately acquired.

(6) The price prediction unit 74 can calculate predicted market clearing prices of future services as predicted prices MCP. In this manner, an optimum predicted price can be acquired in view of supply and demand in the market for providing the future services.

(7) The control parameter selection unit 75 determines, by means of the performance score lower bound setting unit 121 and the control parameter range determination unit 122, a range of control parameter to be used in controlling the BESS 1 based on the past performance scores indicated by the operation history data. Therefore, an optimum range of control parameter can be determined in view of the past performance scores.

(8) The control parameter selection unit 75 determines, by means of the optimum degradation direction determination unit 123, an optimum degradation direction of the battery cell 21 based on an estimated value SOH_Q of state of health in terms of capacity and an estimated value SOH_R of state of health in terms of internal resistance, both of which indicate the state of health of the battery cell 21 estimated by the state estimation unit 72. Therefore, a certain degree of performance score can be secured while restricting the degradation of the battery cell 21.

(9) Based on the predicted price MCP and the price history data, the control parameter selection unit 75 selects, by means of the statistics processing unit 124 and the control mode selection unit 125, any one of a plurality of control modes, at least including the first control mode in which the degradation restriction of the battery cell 21 takes priority, the second control mode in which the performance score takes priority, and the third control mode in which the degradation restriction of the battery cell 21 is compatible with the performance score. Then, the optimization unit 126 selects a control parameter to be used in controlling the BESS 1 based on the selected control mode. Therefore, an optimum control mode is selected according to the situation, and thereby the BESS 1 can be controlled in accordance with the control mode.

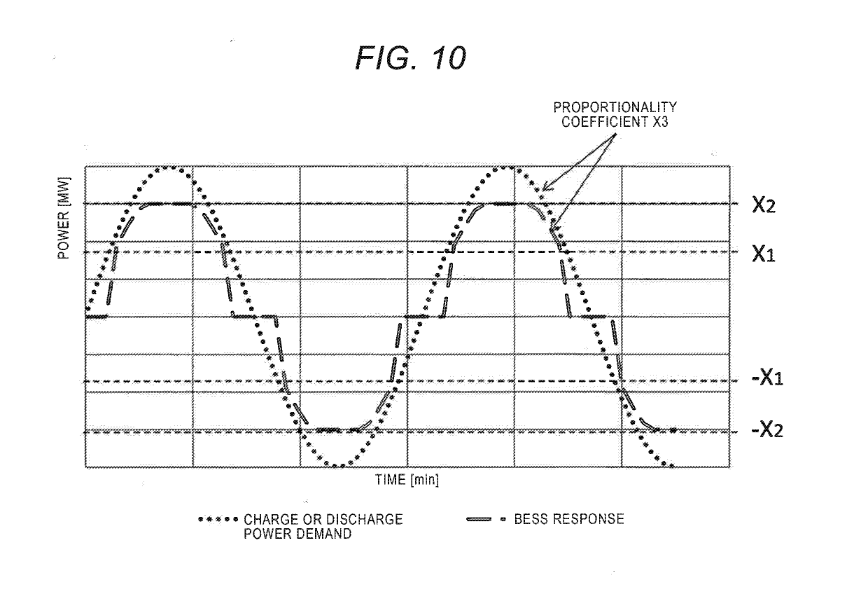

The invention is not limited to the embodiment described above, and a variety of modifications can be included in the invention. For example, a control policy may be determined using a plurality of control parameters at the same time. In this case, the control parameter selection unit 75 can control the charging and discharging of the battery cell 21 by controlling the operation of the PCS 4 based on the plurality of control parameters. FIG. 10 illustrates an example of a relationship between a charge or discharge power demand and a BESS 1 response in a case where charging and discharging are controlled with the control parameters X_1, X_2, and X_3 illustrated in FIG. 3A, FIG. 3B, and FIG. 3C, respectively, being combined. By combining the plurality of control parameters as described above, a user can thoroughly control the operation of the BESS 1 according to fluctuations in charge or discharge power demand. As a result, an optimum control can be realized in order to maximize the life of the BESS 1 and to maximize the total amount of profits.

In addition, a time interval at which the price prediction unit 74 calculates a predicted price MCP of power stabilization service may be irregular. For example, the time interval may be changed according to a form of the BESS 1. In addition, various types of external data may be used in calculating predicted prices MCP.

In addition, without the price prediction unit 74 being provided within the BESS management apparatus 7, the control parameter selection unit 75 may acquire a predicted price MCP of power stabilization service from the outside of the BESS management apparatus 7. In this case, for example, via a communication line provided between a device belongs to other persons concerned or service providers and the BESS management apparatus 7, the BESS management apparatus 7 can acquire the predicted price MCP from the device. In this case, the price history data may be stored in the history database 71.

The aforementioned embodiment and various modification examples are merely examples, and the invention is not limited to the content of the embodiment and the modification examples insofar as the characteristics of the invention are not impaired. The invention is not limited to the aforementioned embodiment and modification examples, and various modifications can be made without departing from the spirit of the invention.

What is claimed is:

1. A battery energy storage system management apparatus for managing an operation of a battery energy storage system which provides a service to stabilize power supply with respect to a power grid using a chargeable and dischargeable battery, comprising:
a history database that stores operation history data related to operation history of the battery energy storage system;
a state estimation unit that estimates a state of health of the battery; and
a control parameter selection unit that selects a control parameter for controlling the operation of the battery energy storage system based on the operation history data stored in the history database, the state of health of the battery estimated by the state estimation unit, and a predicted price of the service.

2. The battery energy storage system management apparatus according to claim 1, further comprising:
a simulation unit that calculates a performance score of the battery energy storage system with respect to providing of the service based on the operation history data stored in the history database and a state of charge and the state of health of the battery estimated by the state estimation unit,
wherein the state estimation unit further estimates the state of charge of the battery, and
the control parameter selection unit selects the control parameter based on the performance score and the predicted price.

3. The battery energy storage system management apparatus according to claim 2,
wherein the simulation unit calculates each of the performance scores with respect to a plurality of the control parameters set for each control policy.

4. The battery energy storage system management apparatus according to claim 3,
wherein the simulation unit further calculates each of a capacity fade amount and an internal resistance increased amount of the battery with respect to the plurality of the control parameters, and
the control parameter selection unit selects the control parameter based on the performance score, the predicted price, and the capacity fade amount and the internal resistance increased amount of the battery.

5. The battery energy storage system management apparatus according to claim 1, further comprising:
a price prediction unit that calculates the predicted price of the service based on price history data stored in the history database,
wherein the history database further stores the price history data related to price history of the service.

6. The battery energy storage system management apparatus according to claim 5,
wherein the price prediction unit calculates a predicted market clearing price of the future service as the predicted price.

7. The battery energy storage system management apparatus according to claim 2,
wherein the control parameter selection unit determines a range of the control parameter based on the past performance score.

8. The battery energy storage system management apparatus according to claim 1,
wherein the control parameter selection unit determines an optimum degradation direction of the battery based on the state of health of the battery estimated by the state estimation unit.

9. The battery energy storage system management apparatus according to claim 1, further comprising:
a simulation unit that calculates a performance score of the battery energy storage system with respect to providing of the service based on the operation history data stored in the history database and a state of charge and the state of health of the battery estimated by the state estimation unit,
wherein the history database further stores price history data related to price history of the service,
the state estimation unit further estimates the state of charge of the battery, and
the control parameter selection unit selects, based on the predicted price and the price history data, any one of a plurality of control modes, at least including a first control mode in which the degradation restriction of the battery takes priority, a second control mode in which the performance score takes priority, and a third control mode in which the degradation restriction of the battery is compatible with the performance score, and selects the control parameter based on the selected control mode.

10. A battery energy storage system management method for managing an operation of a battery energy storage system which provides a service to stabilize power supply with respect to a power grid using a chargeable and dischargeable battery, comprising:
storing operation history data related to operation history of the battery energy storage system in a database; and
causing a computer
to estimate a state of health of the battery, and
to select a control parameter for controlling the operation of the battery energy storage system based on the operation history data stored in the database, the estimated state of health of the battery, and a predicted price of the service.

11. The battery energy storage system management method according to claim 10, further comprising:
causing the computer
to estimate a state of charge of the battery,
to calculate a performance score of the battery energy storage system with respect to providing of the service based on the operation history data stored in the database and the estimated state of charge and state of health of the battery, and
to select the control parameter based on the performance score and the predicted price.

12. The battery energy storage system management method according to claim 11, further comprising:
causing the computer
to calculate each of the performance scores with respect to a plurality of the control parameters set for each control policy.

13. The battery energy storage system management method according to claim 12, further comprising:
causing the computer
to further calculate each of a capacity fade amount and an internal resistance increased amount of the battery with respect to the plurality of the control parameters, and
to select the control parameter based on the performance score, the predicted price, and the capacity fade amount and the internal resistance increased amount of the battery.

14. The battery energy storage system management method according to claim 10, further comprising:
further storing price history data related to price history of the service in the database; and
causing the computer to calculate the predicted price of the service based on the price history data stored in the history database.

15. The battery energy storage system management method according to claim 14, further comprising:
causing the computer to calculate a predicted market clearing price of the future service as the predicted price.

16. The battery energy storage system management method according to claim 11, further comprising:
causing the computer to determine a range of the control parameter based on the past performance score.

17. The battery energy storage system management method according to claim 10, further comprising:
causing the computer to determine an optimum degradation direction of the battery based on the estimated state of health of the battery.

18. The battery energy storage system management method according to claim 10, further comprising:
further storing price history data related to price history of the service in the database; and
causing the computer
to estimate a state of charge of the battery,
to calculate a performance score of the battery energy storage system with respect to providing of the service based on the operation history data stored in the history database and the estimated state of charge and state of health of the battery, and
to select, based on the predicted price and the price history data, any one of a plurality of control modes, at least including a first control mode in which the degradation restriction of the battery takes priority, a second control mode in which the performance score takes priority, and a third control mode in which the degradation restriction of the battery is compatible with the performance score, and to select the control parameter based on the selected control mode.

19. A battery energy storage system, comprising:
the battery energy storage system management apparatus according to claim 1;
a chargeable and dischargeable battery; and
a charging and discharging apparatus that controls charging and discharging of the battery based on a control parameter selected by the battery energy storage system management apparatus.
